(19) United States
(12) Patent Application Publication
(10) Pub. No.: US 2025/0132111 A1
(43) Pub. Date: Apr. 24, 2025

(54) VACUUM CIRCUIT BREAKER

(71) Applicant: ABB Schweiz AG, Baden (CH)

(72) Inventors: Marie Grue, Skien (NO); Felix Boy, Heidelberg (DE); Magnus Nilsen, Skien (NO); Stale Talmo, Skien (NO)

(21) Appl. No.: 18/918,827

(22) Filed: Oct. 17, 2024

(30) Foreign Application Priority Data
Oct. 18, 2023 (EP) 23204328.1

(51) Int. Cl. H01H 33/666

(52) U.S. Cl. CPC H01H 33/666; H01H 2235/01

(57) ABSTRACT

A vacuum circuit breaker comprises a vacuum breaker unit; and a drive unit. The drive unit includes an opening spring for biasing a movable contact of the vacuum breaker unit towards the open position; and a spring tension adjustment mechanism. The spring tension adjustment mechanism comprises an adjustment actuator; and a rigid coupling link connecting the adjustment actuator to the second end portion the opening spring. The adjustment actuator is arranged offset from an opening spring axis.

### CROSS-REFERENCE TO RELATED APPLICATIONS

This application claims priority to European Patent Application No. 23204328.1, filed Oct. 18, 2023 and titled “VACUUM CIRCUIT BREAKER”, the contents of which is hereby incorporated by reference in its entirety.

### TECHNICAL FIELD

Aspects of the present disclosure relate to a circuit breaker, in particular a vacuum circuit breaker, and even more particularly to a vacuum circuit breaker with an opening spring. Aspects of the present disclosure also relate to a method of tensioning the opening spring of such a circuit breaker.

### BACKGROUND

A circuit breaker is a switching device which performs a protective function in an associated electric circuit. A circuit breaker can be actuated between a closed configuration (closed position of movable contact), in which the circuit breaker allows a current flowing between two parts of the associated electric circuit, and an open configuration (open position of movable contact), in which the circuit breaker interrupts such current flowing. In contrast to other types of interrupters, a circuit breaker is adapted and rated for interrupting fault currents, e.g. an overload or short-circuit current.

A circuit breaker includes at least one breaker unit that typically includes a movable contact and a stationary contact. The actuation of a circuit breaker typically involves a mechanism to move the movable contact between the closed position where the movable contact and the stationary contact are in contact, and the open position where the movable contact and the stationary contact are spaced apart from each other.

In a vacuum circuit breaker, the arc extinguishing medium and the insulating medium of the contact gap after the arc is extinguished is vacuum. The arc extinguishing medium and the insulating medium of the contact gap (i.e., vacuum) is often provided within a vacuum enclosure (so-called vacuum bottle) of the breaker unit(s). Vacuum circuit breakers are often used in distribution networks.

Moving the movable contact requires an energy source and a kinematic chain to transmit the energy, provided within specific dimensional limits. Further, the energy source and kinematic chain is subject to strict limits regarding their manufacturing and assembly tolerances, so that the forces and movement of the movable contact meet specifications.

When the circuit breaker is in an open position, it is important to hold the circuit breaker stably in the open position. In a vacuum circuit breaker, however, the under pressure in the vacuum chamber typically results in a force pulling the movable contact towards the closed position. In order to counteract this force, an opening spring may be provided for biasing the movable contact towards the open position.

However, there is a problem that this opening spring must meet strict requirements regarding tolerances, so that the forces and movement of the movable contact continue to meet the specifications.

In view thereof, there is a need in the art for a circuit breaker that is energy-efficient, compact and adjustable.

### BRIEF DESCRIPTION

In view of the current needs, an object of the present disclosure is to provide a vacuum circuit breaker, in particular a vacuum circuit breaker with a drive unit having an opening spring, the vacuum circuit breaker operating reliably in various circumstances without excessive requirements regarding the supplied components and the required space. In particular, a reliable operation without excessive requirements regarding the opening spring is desired.

For providing a brief description of the present disclosure, aspects of the disclosure are described as follows.

According to an aspect, a vacuum circuit breaker comprises a vacuum breaker unit; and a drive unit. The drive unit includes an opening spring for biasing a movable contact of the vacuum breaker unit towards the open position; and a spring tension adjustment mechanism. The spring tension adjustment mechanism comprises an adjustment actuator; and a rigid coupling link connecting the adjustment actuator to the second end portion the opening spring. The adjustment actuator is arranged offset from an opening spring axis.

More specifically, the vacuum breaker unit has a movable contact configured to switch between an open position and a closed position. The drive unit is coupled to the movable contact for actuating a movement between the closed position and the open position, the drive unit including an opening spring operably connected at a first end portion to the movable contact for biasing the movable contact towards the open position. The adjustment actuator is configured to position a second end portion of the opening spring in a plurality of positions corresponding to a plurality of lengths of the opening spring.

According to an aspect, an opening spring is described. The opening spring may be a tension spring. A tension spring differs from other types of springs, such as compression springs, or torsion springs. For example, a tension spring may be configured for receiving a tensile load, e.g. during actuation of the spring, and generate a spring force in response to the tensile load. In a vacuum circuit breaker according to embodiments, a length of the opening spring by which the opening spring is offset from a neutral position by the tensile load may be essentially proportional to the spring force of the opening spring. According to some embodiments, the tension spring may include one or more hooks, particularly for engaging an opening hook and/or a link-spring joint.

Beneficially, a circuit breaker which is cost-efficient and compact is provided.

Further aspects, embodiments and examples, and benefits thereof may be further understood from the detailed description, in reference to the accompany drawings, which are briefly described as follows.

### BRIEF DESCRIPTION OF DRAWINGS

Aspects, embodiments and examples, and benefits thereof of the present disclosure shall emerge more clearly from the detailed description, which is illustrated by way of example and without limitation with the aid of the accompany drawings, in which:

FIG. 1 shows a circuit breaker with a drive unit having a spring tension adjustment mechanism according to aspects and embodiments described herein;

FIG. 2 shows the drive unit with spring tension adjustment mechanism and opening spring in a free-length state according to embodiments and examples described herein;

FIG. 3 shows the drive unit with spring tension adjustment mechanism and opening spring in a pre-tensioned state according to embodiments and examples described herein;

FIG. 4 shows the drive unit with spring tension adjustment mechanism and opening spring in a tensioned position according to embodiments and examples described herein;

FIG. 5 shows the drive unit with the slotted hole and spring positioning slot according to embodiments and examples described herein; and

FIG. 6 illustrates a method of tensioning an opening spring according to aspects and embodiments described herein.

### DETAILED DESCRIPTION

Reference will now be made in more detail to the various aspects and embodiments, one or more examples of which are illustrated in each drawing. Within the following detailed description, the same reference numbers refer to the same or similar components. The reference numbers used in the drawings are merely for illustration.

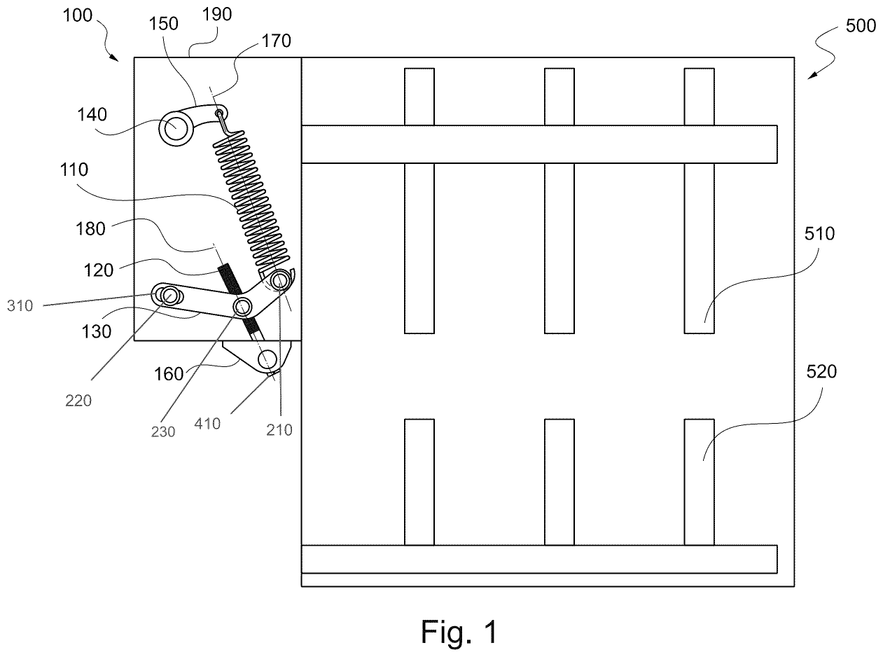

Unless specified otherwise, features illustrated or described as part of one embodiment can be used individually or in conjunction with any other embodiment. The description of a part or aspect in one embodiment applies to a corresponding part or aspect in another embodiment as well, and any aspect described can be combined with any other aspect or embodiment described herein, unless specified otherwise. Each example is provided by way of explanation and is not meant as a limitation. Generally, only the differences with respect to the individual embodiments are described. Even though the reference signs in the following description relate to the embodiments shown in FIGS. 1 to 5 for illustration, the description is not limited to these embodiments unless stated explicitly otherwise.

### Circuit Breaker, Opening Spring and Spring Tension Adjustment Mechanism

FIG. 1 shows a vacuum circuit breaker with an opening spring 110 and a spring tension adjustment mechanism according to aspects and embodiments described herein.

The vacuum circuit breaker comprises a vacuum breaker unit 500 having a movable contact 510 configured to switch between an open position and a closed position; and a stationary contact 520.

The vacuum circuit breaker further comprises a drive unit 100 coupled to the movable contact 510 for actuating a movement between the closed position and the open position, the drive unit 100 including an opening spring 110 operably connected at a first end portion to the movable contact 510 for biasing the movable contact 510 towards the open position.

The vacuum circuit breaker further comprises a spring tension adjustment mechanism. The spring tension adjustment mechanism comprises an adjustment actuator 120 configured to position a second end portion of the opening spring 110 in a plurality of positions corresponding to a plurality of lengths of the opening spring; and a rigid coupling link 130 connecting the adjustment actuator 120 to the second end portion the opening spring 110. The adjustment actuator 120 is arranged offset from an opening spring axis 170.

Beneficially, a circuit breaker with a compact drive unit with an adjustable opening spring 110 is provided. It may be readily appreciated that an opening spring adjustable by a spring tension adjustment mechanism is of great benefit in circuit breakers.

For example, during development, installation and/or maintenance of a circuit breaker, a spring tension adjustment mechanism may be used for determining the optimal or appropriate pre-tension force based on real system friction, tolerance chain, and equilibrium force distribution in the system. Therein, individual tolerances and/or changes of components can be accounted for.

The spring tension adjustment mechanism may also be used for testing the influence of different force settings on the kinematic system, and/or in the optimization or individual adjustment of spring mechanisms to accommodate tolerances and kinematic variations in operational circuit breakers.

It may thus be appreciated that by providing a spring tension adjustment mechanism enabling adjustable tension, length, angle, and/or pre-tension force in the opening spring, it becomes possible to ensure that specifications are met in spite of any manufacturing tolerances or changes. Thereby, it becomes possible to improve reliability and consistency of the circuit breaker.

In addition, both the opening spring and the spring tension mechanism can be provided in a space-saving manner. In particular, providing the spring tension mechanism at a location that does not occupy or reduce space for the spring is of substantial benefit and is space saving.

By arranging the spring tension adjustment mechanism offset from the opening spring axis, the spring tension adjustment mechanism, in particular the adjustment actuator, is outside the design space of the spring, specifically outside of the space defined by the spring axis and the spring coil diameter.

As more space is allowed for the spring itself, a longer spring can be used. A longer spring may be able to accommodate higher pre-tensioned forces at a given spring stiffness, or lower spring stiffness for achieving a given pre-tensioned force. For the opening spring, the pre-tensioned force may be selected for compensating (primarily vacuum-induced) forces acting on the movable contact element towards the closed position. With a longer spring, this pre-tensioned force can be achieved at lower spring stiffness, such that a lower spring stiffness can be used at this spring length to comply with the required pre-tension force. An advantage of a lower spring stiffness is that it reduces energy consumption during actuation of the movable contact element.

At the same time, the spring tension adjustment mechanism is space saving as it does not occupy the space for the opening spring, specifically because it does not operate on the opening spring axis for extending/tensioning the opening spring for example, but is arranged offset from the opening spring axis.

Accordingly, a compact, energy efficient and adjustable circuit breaker is provided.

In an example, the spring tension mechanism is configured to adjust and/or vary one or more of a tension, a length, a pre-tension force, and/or an open-position-angle of the opening spring 110 (i.e. when the movable contact is in the open position, e.g. with respect to the operating lever 150).

Beneficially, a circuit breaker with an opening spring that is both adjustable and space-saving, particularly with respect to the space for the opening spring and spring tension adjustment mechanism, is provided.

### Free-Length State, Pre-Tensioned State and Tensioned State

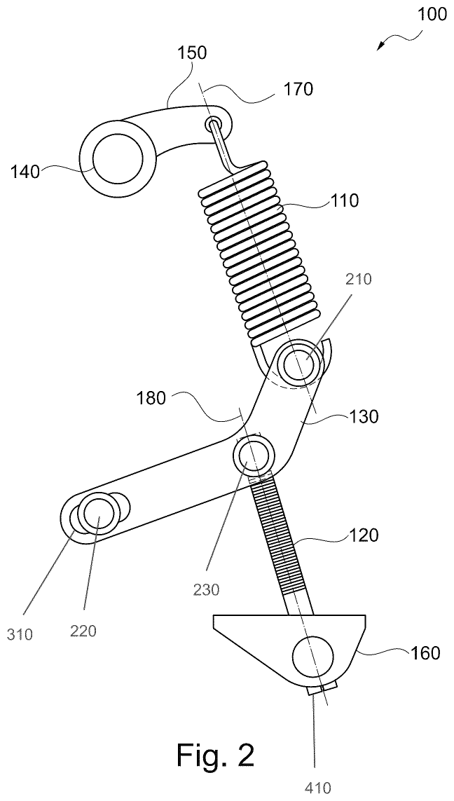

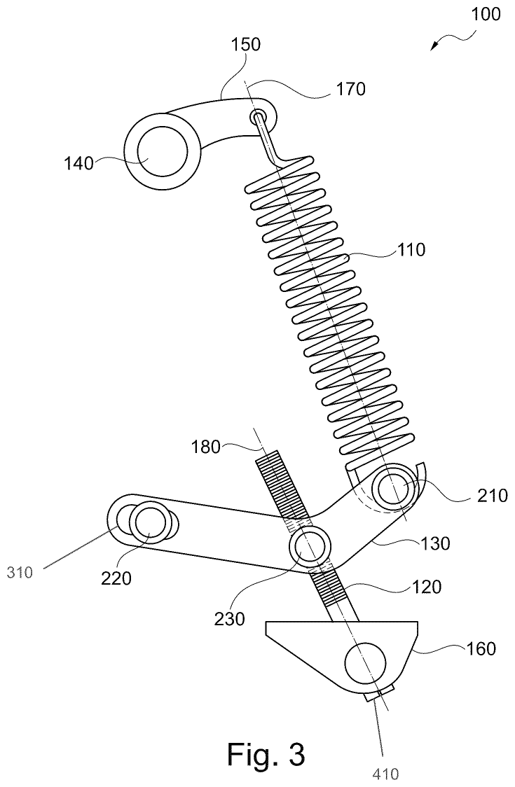

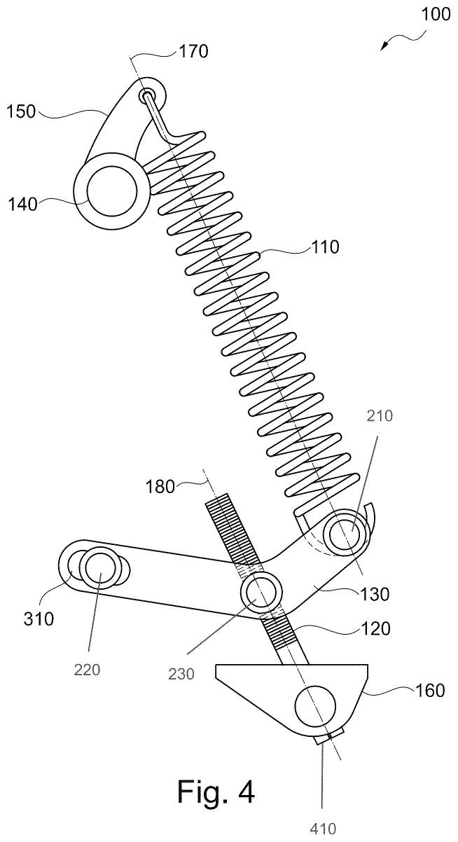

FIG. 2 shows the drive unit with the opening spring in a free-length state. FIG. 3 shows the drive unit with the opening spring in a pre-tensioned state. FIG. 4 shows the drive unit with the opening spring in a tensioned position.

It may be understood that there are a plurality of opening spring states including a free-length state, pre-tensioned state and tensioned state.

It may be understood that when the opening spring 110 is in a free-length state, a length of the opening spring 110 is a free length, so that the opening spring 110 is in equilibrium and generates substantially no force.

Generally, in some embodiments the free-length state is attainable by the drive unit. The free-length state is for example useful for inserting or removing the opening spring 110.

An example of a drive unit attaining the free-length state of the spring is shown in FIG. 2. Here, the free-length state is attained by holding the drive unit in a configuration corresponding to an open position of the moveable contact, as shown in FIG. 2 by the lever 150 being in a rotational position corresponding to the open position of the movable contact. In other words, the angle between the operating lever 150 and the opening spring (or opening spring axis 170) is an open-position angle.

The drive unit may be blocked in this state and/or disconnected from the vacuum breaker unit, for stably holding the drive unit in this configuration in spite of the movable contact being pulled towards the closed position by the vacuum of the vacuum circuit breaker unit.

As further illustrated in FIG. 2, the free-length state may be attainable by loosening the spring tension adjustment unit.

FIG. 3 shows the drive unit with the opening spring in a pre-tensioned state. It may be understood that when the opening spring 110 is in a pre-tensioned state, a length of the opening spring 110 is a pre-tensioned length, longer than the free length, so that the opening spring 110 generates a force biasing the movable contact element towards the open position. The force generated in the pre-tensioned state is generally pre-determined (calibrated) to match or overcome the force pulling the movable contact towards the closed position by the vacuum of the vacuum circuit breaker unit.

Generally, in some embodiments the pre-tensioned state is attainable by the drive unit, when the circuit breaker is in an open configuration (when the drive unit in a configuration corresponding to an open position of the moveable contact, as shown in FIG. 3 by the lever 150 being in a rotational position corresponding to the open position of the movable contact). Thereby, it becomes possible that the opening spring generates, in the open configuration of the circuit breaker, a counterforce overcoming the force pulling the movable contact towards the closed position.

The pre-tensioned state of the spring may be attained by suitably adjusting the spring adjustment mechanism, as illustrated in FIG. 3.

FIG. 4 shows the drive unit with the opening spring in a tensioned position. It may be understood that when the opening spring 110 is in a tensioned state, a length of the opening spring 110 is a tensioned length, longer than the pre-tensioned length. The tensioned state may be attained when the circuit breaker is in a closed configuration (when the drive unit in a configuration corresponding to a closed position of the moveable contact, as shown in FIG. 4 by the lever 150 being in a rotational position corresponding to the closed position of the movable contact).

### Drive Unit

It may be understood that a drive unit 100 may be configured to drive a rotation of the drive shaft 140, in particular for moving the movable contact 510 between the closed position and open position. The drive unit 100 may actuate a movement both ways, from open to closed position and from closed to open position.

In an example, a drive unit may include a drive actuator (not shown) for driving the drive shaft 140 to move the movable contact between the closed position and the open position. The drive actuator is, in embodiments, different from the opening spring 110.

In general, a drive actuator of the drive unit may be realized as a mechanical spring and/or an electromagnetic actuator. Beneficially, a force applied by hand, for example in the range of 0.1 to 100 N is reinforced or augmented by the drive unit. In an example, a drive actuator of the drive unit may provide energy of at least 50 J and/or at most 500 J.

### Opening Spring

A purpose of the opening spring 110 is to provide a well-calibrated force acting on the movable contact 510 in the open configuration of the circuit breaker (when the movable contact 510 is in the open position), in order to hold the movable contact 510 stably in the open position against any forces, such as a vacuum force, acting on the movable contact 510. For this purpose, the opening spring 110 is pre-tensioned in the open configuration of the circuit breaker.

According to an embodiment, a pre-tensioned length of the opening spring 110 is a length of the opening spring 110 when the movable contact 510 is in the open position and the adjustment mechanism is adjusted such that the spring has the predetermined pre-tension according to specifications of the circuit breaker.

In an example, the pre-tensioned length of the opening spring 110 is adjusted, by the spring tension adjustment unit, to match or overcome the force pulling the movable contact towards the closed position by the vacuum of the vacuum circuit breaker unit, as described above.

In an example, the opening spring 110 may store energy when the movable contact 510 is in the closed position (and when the opening spring is in a tensioned position). In a particular example, the opening spring 110 contributes to a breaking operation, in particular by providing energy that is stored when the movable contact 510 is in the closed position to the movable contact during the breaking operation. On the other hand, the main source of energy during a breaking operation is typically a dedicated drive spring which is separate from the opening spring.

During a breaking operation, a contact spring, which may be arranged within a movable contact assembly, e.g. on a respective movable contact 510, and which may be in a compressed state when the movable contact 510 is in the closed position, may form a (primary) source of mechanical or kinetic energy for the breaking operation.

In an example, at the start of the breaking operation, the contribution of mechanical or kinetic energy from an opening spring may be less than the mechanical or kinetic energy from the contact spring.

In an example, during the end of the breaking operation, when the movable contact 510 is nearer to the open position than the closed position, the opening spring 110 may take over from the contact spring to keep or maintain the movable contact 510 in the open position.

According to an embodiment, the opening spring 110 is arranged diagonally within a cuboidal compartment (i.e., with the spring axis 170 non-parallel to the side walls of the compartment). In some embodiments, the spring axis 170 of the opening spring 110 is arranged with an angle of at least 15° and at most 45° with respect to side walls of the compartment. In an embodiment, the spring axis 170 of the opening spring 110 is inclined with respect to side walls of the compartment. The inclination may be towards a line connecting diagonally opposite corners of the compartment, and may in some embodiments be closer to the line than to the respective side walls.

The compartment may be of the drive unit 100 and/or may comprise a frame 190.

As can be readily appreciated, the greatest possible tension length can thus be utilized. In particular, it may be appreciated that the use of an opening spring with lower spring stiffness, which necessitates a greater tension length to achieve the same high pre-tension force, can then be used.

As can be further appreciated, an opening spring with a lower spring stiffness contributes to a lower energy consumption from an energy input source.

According to an embodiment, a spring space includes a plurality of volumes.

Each volume of the plurality of volumes may be understood as a volume that is occupied by the opening spring 110 when the opening spring is at a respective length of the plurality of lengths of the opening spring 110.

Each volume of the plurality of volumes may be understood as a volume that is occupied by the opening spring 110 when the movable contact is in the open position.

Each volume of the plurality of volumes may be understood as a volume that is occupied by the opening spring 110 as installed in the drive unit 100.

According to an embodiment, the plurality of lengths of the opening spring 110 includes a plurality of pre-tensioned lengths and a free length.

Beneficially, the opening spring may be adjusted to a plurality of pre-tensioned lengths, from the free length, by using the spring tension adjustment mechanism.

A pre-tensioned length may be understood as a length of the opening spring 110 when the movable contact 510 is in the open position. A pre-tensioned length may be understood as a length of the opening spring 110 when the opening spring 110 is holding and/or maintaining the movable contact 510 in the open position, in particular, via the operating lever 150 and/or via the operating shaft 140.

A free length may be understood as a length of the opening spring 110 when the opening spring is (completely) un-tensioned and/or when no force is applied to the second end portion via/by the rigid coupling link 130.

### Adjustment Actuator

According to the disclosure, the drive unit comprises a spring tension adjustment mechanism. The spring tension adjustment mechanism comprises an adjustment actuator 120 configured to position a second end portion (lower end portion in FIGS. 1-4) of the opening spring 110 in a plurality of positions corresponding to a plurality of lengths of the opening spring 110. The spring tension adjustment mechanism further comprises a rigid coupling link 130 connecting the adjustment actuator 120 to the second end portion the opening spring 110. The adjustment actuator 120 is arranged offset from an opening spring axis 170. The offset arrangement allows for a space-saving design.

The adjustment actuator 120 may define an actuator axis 180, and may comprise a movable adjustment element which is arranged to be movable along the actuator axis 180 upon actuation of the adjustment actuator 120 for adjusting the spring pre-tension. For example, the adjustment actuator 120 may comprise a threaded bolt, and the movable adjustment element may be a nut with an inner thread adapted to move up and down along the actuator axis 180 upon rotation of the bolt. The nut may be connected to the rigid coupling link 130 (e.g., through a pulling claw). The nut may for example be part of an actuator joint 230 arranged on the rigid coupling link 130 and coupling the rigid coupling link 130 to the adjustment actuator 120. The rigid coupling link 130 is coupled to the opening spring 110. Specifically, the rigid coupling link 130 is coupled to the second end portion the opening spring 110 via the link-spring joint 210.

According to an embodiment, the adjustment actuator 120 is arranged outside of the spring space, i.e., the space enclosed by the spring and also outside of a space of a virtual continuation of the spring along the spring axis.

According to an embodiment, an actuation axis 180 of the adjustment actuator 120 is within 45 degrees, in some embodiments within 30 degrees, and in some embodiments within 20 degrees of being parallel to the opening spring axis 170. This arrangement of the actuation axis is beneficial with respect to reaction forces acting on parts of the spring tension adjustment mechanism upon opening or closing the circuit breaker.

Beneficially, if the centre lines of the actuation and the opening spring are approximately parallel, a bending moment in the adjustment actuator may be reduced.

According to an embodiment, the adjustment actuator 120 has an actuation length that is longer than a length for extending the opening spring 110 from a free length to a pre-tensioned length.

According to an embodiment, the adjustment actuator 120 is fixedly mounted to a frame 190 via a fixing attachment 160. The fixing attachment 160 may be understood to be fixedly attached to the frame 190.

According to an embodiment, the adjustment actuator 120 is arranged outside of both the space for the opening spring 110 and outside of the tension direction of the opening spring 110 outside of the opening spring axis 170 and diameter of the opening spring 110.

Beneficially, the adjustment actuator for adjusting the opening spring is arranged to maximize the space for the spring such that the greatest possible tension length can be utilized and an opening spring with lower spring stiffness can be used.

According to an embodiment, the adjustment actuator is configured to be connectable to the rigid link at a plurality of positions along an adjustment length of the adjustment actuator for positioning the opening spring in the plurality of positions

According to an embodiment, an actuatable distance of the adjustment actuator 120 is longer than a length for extending the opening spring 110 from a free length to a pre-tensioned length.

Beneficially, the opening spring can be extended from a free length beyond a pre-tensioned length and thus the opening spring is adjustable to more than one pre-tensioned length.

In an example, the adjustment actuator 120 is a bolt, in particular a tensioning bolt or a bolt for tensioning the opening spring 110. In other examples, the adjustment actuator 120 is a rack and pinion, a jackscrew, or other positioning devices, and/or is electrically actuated and/or operator/manually actuated.

In an example, the adjustment actuator 120 (e.g., tensioning bolt), is mounted offset with respect to the link-spring joint 210.

In an example, the adjustment actuator 120 may be operated to increase or decrease a tension force of the opening spring 110.

In a particular example, the adjustment actuator 120 is a tensioning bolt and the tensioning bolt may be tightened or loosed to increase or decrease a tension force of the opening spring 110 respectively.

In an example, an actuatable portion 410 of the adjustment actuator 120 is accessible from a side or from outside of a compartment or frame 190 of the drive unit 100.

Beneficially, spring tension may be adjusted easily without requiring disassembly of the drive unit.

In an example, where the adjustment actuator 120 is a tensioning bolt, the actuatable portion 410 of the adjustment actuator 120 may be a head of the tensioning bolt which is accessible from an outer side of the frame 190 of the drive unit 100.

Beneficially, spring tension may be adjusted easily with a standard tool without requiring time-consuming operations such as disassembly.

### Rigid Coupling Link

The adjustment actuator 120 is configured to position a second end portion of the opening spring 110 in a plurality of positions corresponding to a plurality of lengths of the opening spring. For this purpose, a rigid coupling link 130 connects the adjustment actuator 120 (specifically, a movable part of the adjustment actuator such as a nut) to the second end portion the opening spring 110.

According to an embodiment, the rigid coupling link 130 is configured for transforming a movement between each pair of postures of a plurality of postures of the adjustment actuator 120 (specifically, of its movable part) to a movement between each respective pair of positions of the plurality of positions of the second end portion of the opening spring 110.

According to an embodiment, the rigid coupling link 130 is configured for transforming a movement of the adjustment actuator 120 to a change of position of the second end portion of the opening spring 110 via a levering movement of the rigid coupling link 130 in particular with the base joint 220 acting as a fulcrum for the levering movement.

According to an embodiment, the rigid coupling link 130 is anchored to a frame 190 in such a manner that for each configuration of the adjustment actuator 120 (e.g., for each position of its movable part), a unique respective position of the rigid coupling link 130 is defined. Thereby, also a unique respective position of the second end portion of the opening spring 110 may be defined in dependence of the configuration of the adjustment actuator 120.

According to an embodiment, the rigid coupling link 130 is anchored to a frame 190 via a base joint 220. The base joint 220 may include a rotatable degree of freedom, a translational degree of freedom, or both (as illustrated in FIGS. 1-5).

According to a particular embodiment, the rigid coupling link 130 is anchored to a frame 190 via a rotatable base joint 220 for transforming a movement between each pair of postures of a plurality of postures of the adjustment actuator 120 to a movement between each respective pair of positions of the plurality of positions of the second end portion of the opening spring 110 via a levering movement of the rigid coupling link 130 with the base joint 220 acting as a fulcrum for the levering movement.

In an example, the rigid coupling link 130 is a tensioning lever and/or a lever to transfer a tensioning force (provided by the adjustment actuator 120) to the opening spring 110.

In an example, the rigid coupling link 130 is fixed to a frame 190 and/or hinged at a base joint 220.

In an example, the rigid coupling link 130 is a hinged tensioning lever. In an example, the rigid coupling link 130 includes a rotatable joint, e.g., a rotational pinbolt, coupling the rigid coupling link 130 to the adjustment actuator 120.

### Base Joint Slot and Spring Positioning Slot

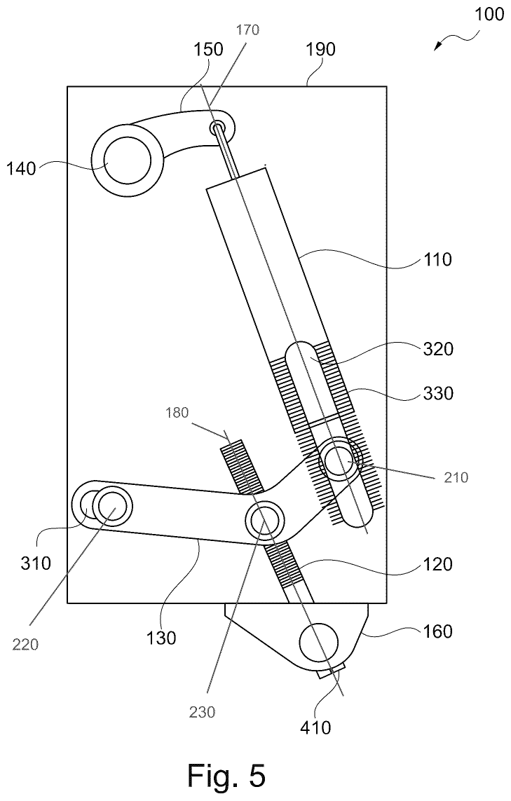

FIG. 5 shows the drive unit with the slotted hole and spring positioning slot according to embodiments and examples described herein.

According to an embodiment, the base joint 220 is at a first end portion of the slotted hole 310 when a length of the opening spring 110 is a first pre-tensioned length and the base joint 220 is at a second end portion of the slotted hole 310 when a length of the opening spring 110 is a second pre-tensioned length.

According to an embodiment, which may be combined with other embodiments, the second end portion of the slotted hole 310 is nearer to the opening spring 110 than the first end portion of the slotted hole 310 and the second pre-tensioned length is longer than the first pre-tensioned length.

According to an embodiment, the base joint 220 allows a translational motion of the rigid coupling link 130 and/or the spring relative to the frame 190. As illustrated in FIG. 5, this translational motion may be enabled by the base joint 220 comprising a slotted hole 310 in the rigid coupling link 130, as shown in FIG. 5. Here, the base joint 220 has a coupling protrusion in the frame 190, and the rigid coupling link 130 has a slotted hole, allowing a sliding motion, in addition to the rotational motion, of the rigid coupling link 130. The sliding motion allows for sufficient degrees of freedom so that the rigid coupling link 130 may slide along the slotted hole 310.

Alternatively, a coupling protrusion of the base joint 220 may be fixed to rigid coupling link 130, and be slidable within a slotted hole provided in the frame 190 (not shown in FIG. 5).

According to an embodiment, the drive unit 100 includes a spring positioning slot 320 in which a part of the spring adjustment mechanism is slidably and at least partially arranged.

According to an embodiment, the drive unit 100 includes a spring positioning slot 320. A slider coupled to the second end portion of the opening spring 110 is slidable along the spring positioning slot 320. The slider may, in particular, be a protrusion of a (rotational) link-spring joint 210. coupling the rigid coupling link 130 to the second end portion of the opening spring 110. Thereby, the link-spring joint 210 is slidable along the spring positioning slot 320.

According to an embodiment, an axis of the spring positioning slot 320 is parallel to the opening spring axis 170 (at least up to a tolerance of at most 10°, in some embodiments at most 5°, and in some embodiments at most) 2°. This configuration allows a setup in which the opening spring axis 170 remains essentially unchanged under spring adjustment.

According to an embodiment, the drive unit 100 includes a plurality of markings 330 arranged alongside the spring positioning slot 320. According to an embodiment, the plurality of markings 330 correspond to a plurality of pre-tensioned lengths of the opening spring 110. Thereby, beneficially, the opening spring may be easily adjusted or set to a desired pre-tension.

According to an embodiment, a rotatable link-spring joint 210 and a rotatable link-actuator joint 230 are arranged on the rigid coupling link 130 coupling the rigid coupling link 130 with the adjustment actuator 120 and the opening spring 110 respectively.

In an example, a link-spring joint 210 coupling the rigid coupling link 130 to the opening spring 110 is arranged to be slidable within a spring positioning slot 320 that is arranged in a frame 190 of the circuit breaker.

In an alternative embodiment, the rigid coupling link 130 is anchored to a frame 190 via a purely rotational base joint 220 (e.g., without the slotted hole 310 shown in FIG. 5). In this case, a spring positioning slot 320 can be omitted or replaced by a slot following the circular movement of the link-spring joint 210 about the rotational base joint 220.

### Link-Actuator Joint, Link-Spring Joint and Base Joint

According to an embodiment, the base joint 220 is arranged offset from the opening spring axis 170.

According to an embodiment, the rigid coupling link 130 is coupled to the adjustment actuator 120 at a link-actuator joint 230 that is offset from a line connecting the link-spring joint 210 and a base joint 220.

According to an embodiment, the link-spring joint 210 couples the rigid coupling link 130 to the opening spring 110 and the base joint 220 couples the rigid coupling link 130 to a frame of the circuit breaker.

In an example, the adjustment actuator 120 is connected to the opening spring 110 through a link-spring joint 210. In an example, the link-spring joint 210 is a spring pinbolt joint. In an example, the base joint 220 is a pivot pinbolt joint.

### Fixing Attachment and Frame

According to an embodiment, the circuit breaker includes a frame 190.

In an example, the frame 190 at least partially surrounds the drive unit 100. In a particular example, the frame 190 at least partially forms a compartment in which the drive unit 100 is arranged.

According to an embodiment, the adjustment actuator 120 is fixed to the frame 190 via a fixing attachment 160.

In an example, the fixing attachment 160 is mounted on the frame 190. In an example, the fixing attachment 160 includes a rotatable actuator-frame joint.

In an example, the adjustment actuator 120 is fixed to the fixing attachment 160 via the rotatable actuator-frame joint.

According to an embodiment, the adjustment actuator 120 extends at least a length from the fixing attachment to a second end portion of the opening spring 110 (in a direction parallel to the opening spring axis 170), the opening spring 110 being in a free-length state.

### Operating shaft and operating lever

According to an embodiment, the drive unit 100 includes an operating shaft 140 and an operating lever 150.

The operating lever 150 may be understood to be arranged on the operating shaft 140.

The opening spring 110 may be understood to be operably connected to the vacuum breaker unit 500, in particular the movable contact 510, via (at least) the operating lever 150 and/or via the operating shaft 140.

According to an embodiment, when the movable contact 510 is in the open position, the operating lever 150 and the opening spring 110 are within 30 degrees of perpendicular to each other, in some embodiments within 20 degrees of perpendicular to each other, and in some embodiments within 10 degrees of perpendicular to each other.

Beneficially, in the open position, the operating lever and spring angle are substantially perpendicular and a torque by the opening spring holding the movable contact in the open position is maximized.

According to an embodiment, when the movable contact 510 is in a closed position, an angle between the operating lever 150 and the opening spring axis 170 is less than 70degrees, in some embodiments less than 60 degrees, and in some embodiments less than 50 degrees.

Beneficially, in the closed position, the operating lever and spring angle is small and reaction torque is reduced.

According to an embodiment, the operating shaft 140 and/or operating lever 150 is arranged to transfer an opening force of the opening spring 110 to the movable contact 510, in particular for moving the movable contact towards the open position.

### Method of Tensioning the Opening Spring

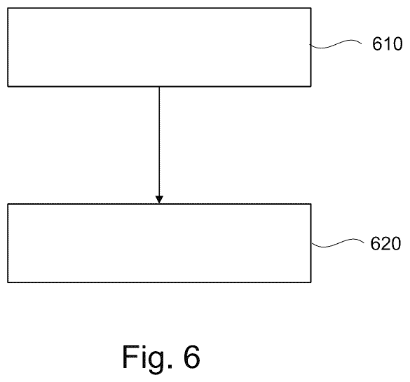

FIG. 6 shows a method of tensioning an opening spring according to aspects and embodiments described herein.

According to an aspect, a method of tensioning the opening spring of the vacuum circuit breaker includes pre-tensioning the opening spring by actuating the adjustment actuator 610.

In an example, where the adjustment actuator is a tensioning bolt, actuating the adjustment actuator to pre-tension the opening spring includes tightening or loosening a tensioning bolt.

According to an embodiment, the method includes setting the opening spring to a pre-tensioned length different from a predetermined pre-tensioned length by actuating the adjustment actuator 620.

In an example, where the adjustment actuator 120 is a tensioning bolt, actuating the adjustment actuator to pre-tension the opening spring to a pre-tensioned length different from a predetermined pre-tensioned length includes tightening or loosening the tensioning bolt.

A pre-determined pre-tensioned length may be understood as a pre-tensioned length determined before installation or before assembly of the circuit breaker.

A pre-tensioned length different from the pre-determined pre-tensioned length may be understood as a pre-tensioned length adapted for post-installation and/or post-assembly variance, in particular in the kinematic chain of the circuit breaker, e.g. of the drive unit 100.

### Further Aspects of the Circuit Breaker

Generally, a circuit breaker may be understood as a device adapted to control and protect the grid. According to an aspect, a circuit breaker may be a vacuum circuit breaker and/or a vacuum circuit breaker.

In an example, it may be understood that a circuit breaker as described herein is rated for operating with voltages in excess of 1 kV. For example, the circuit breaker may be a medium-voltage circuit breaker and/or rated to operate at voltages in the range of 1 kV to 72 kV, in some embodiments in the range of 10 kV to 42 kV.

In an example, it may be understood that a circuit breaker as described herein is rated for operating with a nominal current of more than of 100 A, in some embodiments at least 400 A and/or at most 5000 A, and/or a short-circuit current in excess of 10 kA rms, in some embodiments at least 14 kA rms and/or at most 50 kA rms (a high short-circuit current load).

In an embodiment, the circuit breaker, in particular the vacuum breaker unit 500, includes a gas-tight housing. In an embodiment the gas-tight housing is filled or configured to be filled with a dielectric medium. In an embodiment, th vacuum breaker unit 500 further includes at least one so-called vacuum bottle (not shown in FIG. 1) within this gas-tight housing. Each vacuum bottle is a respective gas-tight vacuum housing arranged within the housing of the vacuum breaker unit 500. The pair (or pairs) of circuit breaker contacts 510, 520 of the circuit breaker is (are) provided in a respective one of the at least one vacuum bottle, the circuit breaker contacts 510, 520 being in the open configuration separated from each other by the vacuum within the respective vacuum bottle.

In an embodiment, a dielectric medium within the gas-tight housing of the breaker unit 500 may be a dielectric gas such as SF6, but in some embodiments is a dielectric gas having a global warming potential less than that of SF6. In an example, the dielectric medium is air, dry air, N2, CO2 or mixture of two or three of N2, O2, and CO2. In an example, the dielectric medium is a mixture of air, fluoroketones and/or AirPlus™. In an embodiment, the dielectric medium is a mixture of air and/or fluoroketones. The dielectric medium may surround the at least one vacuum bottle arranged within the housing of the breaker unit 500.

In an embodiment, the drive unit 100 is arranged outside of the gas-tight housing of the vacuum breaker unit 500 and transmits the driving motion to the breaker unit 500 (specifically, to the movable contact(s) 510), through a rotatable shaft 140 partially extending into the gas-tight housing. Beneficially, improved access to the drive unit 100 is provided.

While a vacuum breaker unit 500 including a movable contact 510 and a stationary contact 520 is described herein, a circuit breaker as described herein may be understood to comprise a plurality of breaker units, in particular 3 breaker units, each including a movable contact and a stationary contact respectively. The contacts 510, 520 of each of the breaker units are then provided in respective separate gas-tight vacuum housings of the breaker units. In an embodiment, all movable contacts of the vacuum breaker unit 500 are actuated by the same drive unit through a common drive shaft.

Beneficially, a multiphase circuit breaker is provided, in particular a circuit breaker for a 3-phase electrical circuit/network. The multiphase circuit breaker may have a plurality of pairs of circuit breaker contacts 510, 520 (arranged within multiple respective vacuum bottles). The movable contacts 510 of these pairs may be actuated by a single common shaft 140.

While the present disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art in implementing the claimed disclosure, from a study of the drawings, the disclosure, and the appended claims.

In the claims, the word “comprising” does not exclude other elements, and the indefinite article “a” or “an” does not exclude a plurality. A single element or other unit may fulfill the functions of several items recited in the claims. The mere fact that certain features are recited in mutually different embodiments or in dependent claims does not indicate that a combination of these features cannot be used to advantage. The scope of protection of the present application covers any possible combination of features recited in the various embodiments or in the dependent claims, without departing from the spirit and scope of the application.

1-15. (canceled)

16. A vacuum circuit breaker comprising:
a vacuum breaker unit having a movable contact configured to switch between an open position and a closed position;
a drive unit coupled to the movable contact for actuating a movement between the closed position and the open position, the drive unit including an opening spring operably connected at a first end portion to the movable contact for biasing the movable contact towards the open position; and
a spring tension adjustment mechanism comprising:
an adjustment actuator configured to position a second end portion of the opening spring in a plurality of positions corresponding to a plurality of lengths of the opening spring; and
a rigid coupling link connecting the adjustment actuator to the second end portion the opening spring;
wherein the adjustment actuator is arranged offset from an opening spring axis.

17. The vacuum circuit breaker according to claim 16, wherein the adjustment actuator is arranged outside of a spring space, the spring space comprising a plurality of volumes corresponding to the plurality of positions of the opening spring.

18. The vacuum circuit breaker according to claim 16, wherein the opening spring is arranged diagonally in a cuboidal compartment.

19. The vacuum circuit breaker according to claim 16, wherein the plurality of lengths of the opening spring includes a plurality of pre-tensioned lengths and a free length.

20. The vacuum circuit breaker according to claim 16, wherein the rigid coupling link is anchored to a frame via a rotatable base joint.

21. The vacuum circuit breaker according to claim 16, wherein the rigid coupling link is anchored to a frame via a rotatable base joint for transforming a movement between each pair of postures of a plurality of postures of the adjustment actuator to a movement between each respective pair of positions of the plurality of positions of the second end portion of the opening spring.

22. The vacuum circuit breaker according to claim 16, wherein the rigid coupling link is anchored to a frame via a rotatable base joint for transforming a movement between each pair of postures of a plurality of postures of the adjustment actuator to a movement between each respective pair of positions of the plurality of positions of the second end portion of the opening spring via a levering movement of the rigid coupling link with the base joint acting as a fulcrum for the levering movement.

23. The vacuum circuit breaker according to claim 22, wherein the base joint allows at least one selected from the group consisting of:
a rotatable movement of the rigid coupling link, and
a translational movement of the rigid coupling link.

24. The vacuum circuit breaker according to claim 23, wherein the base joint is arranged offset from the opening spring axis.

25. The vacuum circuit breaker according to claim 24, wherein the base joint is at a first end portion of the slotted hole when a length of the opening spring is first pre-tensioned length, and the base joint is at a second end portion of the slotted hole when a length of the opening spring is a second pre-tensioned length.

26. The vacuum circuit breaker according to claim 25, wherein the second end portion of the slotted hole is nearer to the opening spring than the first end portion of the slotted hole and wherein the second pre-tensioned length is longer than the first pre-tensioned length.

27. The vacuum circuit breaker according to claim 16, wherein the drive unit further comprises a spring positioning slot, and slider coupled to the second end portion of the opening spring, the slider being slidable along the spring positioning slot.

28. The vacuum circuit breaker according to claim 27, wherein an axis of the spring positioning slot is parallel to the opening spring axis.

29. The vacuum circuit breaker according to claim 27, wherein the drive unit further comprises a plurality of markings arranged alongside the spring positioning slot, the plurality of markings corresponding to a plurality of pre-tensioned lengths of the opening spring.

30. The vacuum circuit breaker according to claim 16, wherein the drive unit further comprises a rotatable link-actuator joint coupling the rigid coupling link with the adjustment actuator and a rotatable link-spring joint coupling the rigid coupling link and the opening spring respectively.

31. The vacuum circuit breaker according to claim 16, wherein the drive unit further comprises an operating shaft and an operating lever arranged on the operating shaft, wherein the opening spring is operably connected to the vacuum breaker unit via the operating lever and the operating shaft.

32. The vacuum circuit breaker according to claim 31, wherein when the movable contact is in the open position, the operating lever and the opening spring are within 30 degrees of perpendicular to each other.

33. The vacuum circuit breaker according to claim 16, wherein the opening spring is a tension spring.

34. A method of tensioning an opening spring of a vacuum circuit breaker, the vacuum circuit breaker comprising:
a vacuum breaker unit having a movable contact configured to switch between an open position and a closed position;
a drive unit coupled to the movable contact for actuating a movement between the closed position and the open position, the drive unit including an opening spring operably connected at a first end portion to the movable contact for biasing the movable contact towards the open position; and
a spring tension adjustment mechanism comprising:
an adjustment actuator configured to position a second end portion of the opening spring in a plurality of positions corresponding to a plurality of lengths of the opening spring; and
a rigid coupling link connecting the adjustment actuator to the second end portion the opening spring;
wherein the adjustment actuator is arranged offset from an opening spring axis, the method comprising pre-tensioning the opening spring by actuating the adjustment actuator.

35. The method according to claim 34, wherein movable contact is kept in an open position during the pre-tensioning.
